(19) United States
(12) Patent Application Publication
(10) Pub. No.: US 2004/0251111 A1
(43) Pub. Date: Dec. 16, 2004

(54) Directional input device

(76) Inventor: Donald L. LeCroy, Mableton, GA (US)

Correspondence Address: Eric T. Krischke, Pauley Petersen & Erickson, Suite 365, 2800 West Higgins Road, Hoffman Estates, IL, 60195, US

(21) Appl. No.: 10/861,307

(22) Filed: Jun. 4, 2004

Related U.S. Application Data
(60) Provisional application No. 60/477,442, filed on Jun. 10, 2003.

(51) Int. Cl. B65G 47/10

(52) U.S. Cl. 198/395

(57) ABSTRACT

A directional input device includes a transfer belt having a conveying surface. A first plow assembly is positioned with respect to the transfer belt, and includes a first plow belt positioned generally perpendicular to the transfer belt. A drive unit is operatively connected to the first plow assembly. In one preferred embodiment of this invention, a directional input device system includes a queuing belt; a directional input device positioned downstream from the queuing belt, and including a transfer belt having an entrance end portion operatively connected to a discharge end portion of the queuing belt and a plow-centering unit; and a machine positioned downstream from the directional input device having a machine belt operatively connected to a discharge end portion of the transfer belt.

### CROSS REFERENCE TO RELATED APPLICATION

This application claims the benefit of U.S. Provisional Application No. 60/477,442, filed 10 Jun. 2003.

### BACKGROUND OF THE INVENTION

This invention relates generally to an apparatus for aligning and/or centering objects with respect to a conveyor system and, more particularly, to a directional input device for aligning and/or centering objects, such as boxes, packages and/or luggage, with respect to a system restriction, such as a machine opening.

Conventional conveyor systems typically include a plurality of conveyor belts for transferring or conveying objects, such as luggage, through a machine to screen the contents of the luggage for firearms, drugs, explosives and/or other potentially dangerous items. The conveyor belts are generally positioned in a series with respect to each other to provide a conveyor system for conveying or moving objects from a first location to a second location. For example, pieces of luggage may be placed on a first conveyor belt, which conveys or moves the luggage to a second conveyor belt. The second conveyor belt may then move or convey the luggage through a security screening machine to screen the contents of each piece of luggage. The conveyor belts typically have a fixed width, which may not correspond with an opening in the security screening machine for receiving the objects. Thus, as the objects move toward and/or into the machine opening, at least one of the objects may become misaligned and prevent the object from passing through the opening. This obstruction further prevents other objects from moving through the machine. An operator must then stop the conveyor system and remove and/or align the object with the machine opening before continuing to screen the objects.

### SUMMARY OF THE INVENTION

One object of the invention is to provide a directional input device system for aligning objects conveyed on a conveyor system with an opening in a machine used for screening the contents of the objects, for example, to provide a continuous system operation.

Still another object of the invention is to overcome one or more of the problems described above.

The above and other objects of the invention can be attained through a directional input device for conveying an object with respect to a system restriction, such as an opening formed in a downstream machine, a narrowing of the conveyor system belt or a change in direction of the conveyor system, for example. The directional input device includes a transfer belt having a conveying surface, which extends toward the opening or system restriction. A first plow belt is positioned with respect to the transfer belt, preferably generally perpendicular to the transfer belt. A drive unit is operatively connected to the first plow belt to drive the first plow belt relative to the transfer belt.

The prior art generally fails to provide a directional input device having a plow assembly including a plow belt that is positioned generally perpendicular to the transfer belt, and operatively controlled by a drive unit, for aligning objects conveyed on a transfer belt with a system restriction, such as an opening formed by or in a machine for example, to provide a continuous system operation.

The invention further comprehends a directional input device for aligning an object with respect to an opening formed by a machine that includes a transfer belt having a conveying surface extending toward the opening. A plow-centering unit is mounted with respect to the conveying surface and includes a first plow assembly positioned with respect to a first edge portion of the transfer belt and a second plow assembly positioned with respect to a second edge portion of the transfer belt. The first plow assembly and the second plow assembly each includes a plow belt, which is preferably positioned generally perpendicular to the transfer belt. A reversible drive unit is operatively connected to the first plow assembly to drive the first plow belt relative to the transfer belt. Preferably, the drive unit is also operatively connected to the second plow assembly to drive the second plow belt relative to the transfer belt. Alternatively, an independent second drive unit can be operatively connected to the second plow assembly to drive the second plow belt relative to the transfer belt, in cooperation with or independently of the first plow belt, as desired.

The invention still further comprehends a luggage handling system including a queuing belt. A directional input device is positioned downstream from the queuing belt, and includes a transfer belt having an entrance end portion operatively connected to a discharge end portion of the queuing belt and a plow-centering unit. A machine is positioned downstream from the directional input device, and has a machine belt operatively connected to a discharge end portion of the transfer belt. The machine forms an opening that corresponds to a width of the transfer belt discharge end portion.

Other objects and advantages of the invention are apparent to those skilled in the art, in view of the following detailed description taken in conjunction with the appended claims and drawings.

### BRIEF DESCRIPTION OF THE DRAWINGS

FIG. 1 is a perspective view of a directional input device system including a directional input device positioned between a queuing belt and a security screening machine, according to one preferred embodiment of this invention, wherein:

FIG. 2 is a front view of a directional input device system including a directional input device positioned between a queuing belt and a security screening machine, according to one preferred embodiment of this invention;

FIG. 3 is a side view of a directional input device system including a directional input device positioned between a queuing belt and a security screening machine, according to one preferred embodiment of this invention;

FIG. 4 is a top view of a directional input device system including a directional input device positioned between a queuing belt and a security screening machine, according to one preferred embodiment of this invention;

FIG. 5 is a bottom view of a directional input device system including a directional input device positioned between a queuing belt and a security screening machine, according to one preferred embodiment of this invention;

FIG. 6 is a top view of a directional input device system in partial cross-section including a directional input device positioned between a queuing belt and a security screening machine, according to one preferred embodiment of this invention;

FIG. 7 is a top view of a directional input device system in partial cross-section, including a directional input device positioned between a series of queuing belts and a security screening machine, according to one preferred embodiment of this invention;

FIG. 8 is a side view of a portion of the directional input device of FIG. 7, according to one preferred embodiment of this invention; and

FIG. 9 illustrates an object being aligned and/or centered as the object is conveyed onto and along a transfer belt of a directional input device, according to one preferred embodiment of this invention.

### DETAILED DESCRIPTION OF THE INVENTION

The present invention provides a directional input device system, such as a luggage handling system, comprising a directional input device (DID) for aligning and/or centering objects with respect to a system restriction, such as an opening formed in or by a machine positioned downstream from the directional input device. For example, in one preferred embodiment of this invention, the directional input device aligns and/or centers objects that are transferred or conveyed from a conveyor system onto a transfer belt of the directional input device. Preferably, the objects are aligned and/or centered with respect to a longitudinal centerline of the directional input device, as the objects are transferred or conveyed from a queuing belt onto and along the transfer belt and through the directional input device to a machine positioned downstream from the directional input device, such as an Explosive Detection System (EDS) or any suitable security screening machine, for example.

Although the following description describes a directional input device for use in combination with a security screening device or machine, the directional input device of the present invention is not limited in use to any particular application, wherein the directional input device and/or any combined or associated machine has certain dimensional restrictions and/or requirements. The directional input device of the present invention can be used with any conveying system or application, wherein objects such as boxes, bags, parcels and/or luggage are conveyed, transferred, moved, aligned, centered, screened and/or sorted. Further, the directional input device system of the present invention can include any suitable combination of components as described herein.

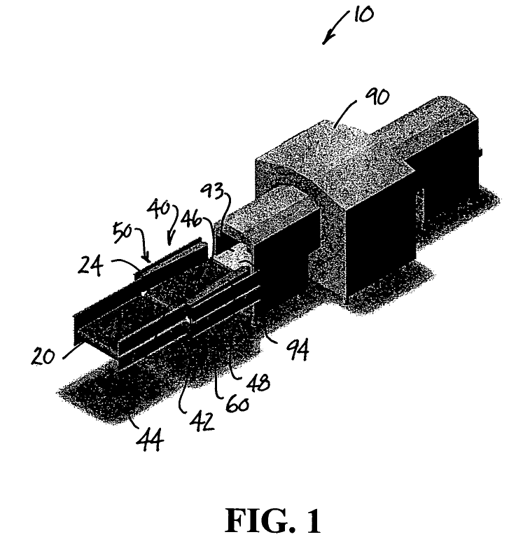

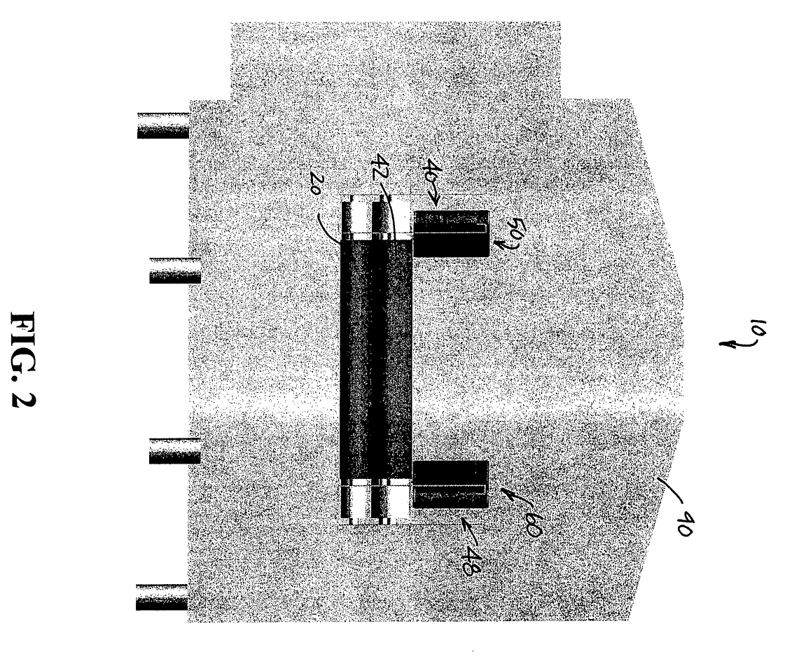

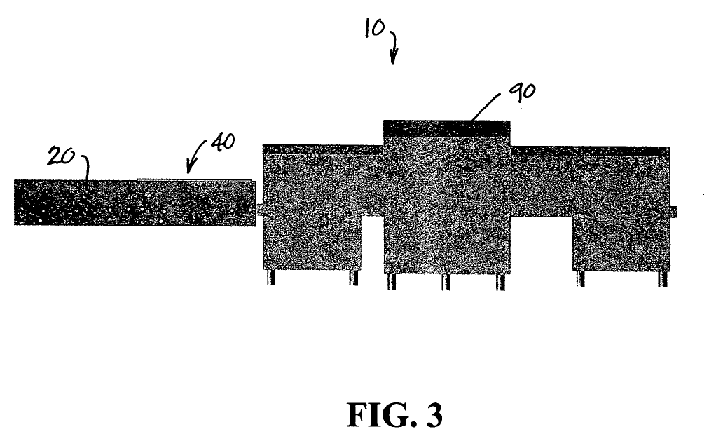

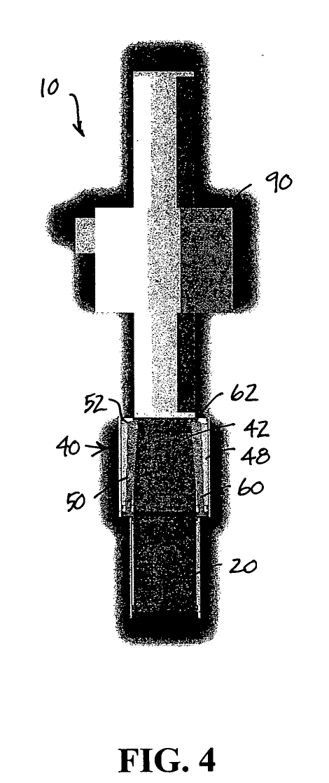

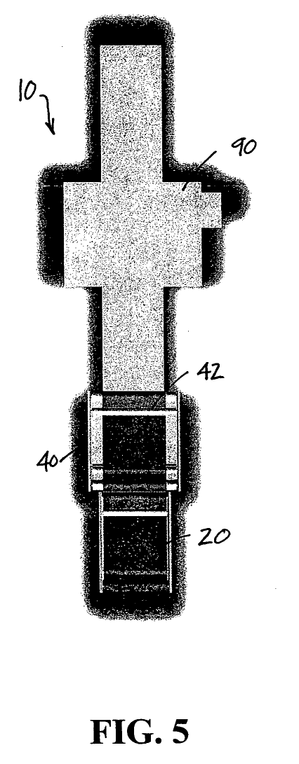

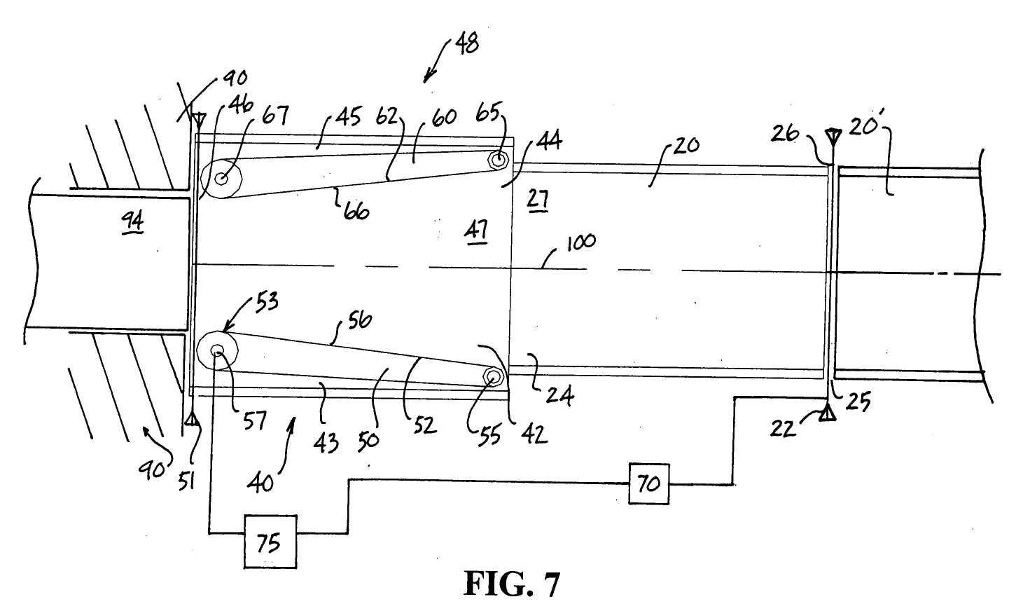

Referring to FIGS. 1-9, a directional input device system 10 comprises a queuing belt 20. In one preferred embodiment of this invention, queuing belt 20 preferably has a width of about 30 inches to about 48 inches, more preferably about 36 inches to about 40 inches, and in many cases about 39 inches. It should be apparent to those having ordinary skill in the art and guided by the teachings herein provided that queuing belt 20 can have any suitable width and/or length. Further, queuing belt 20 can be made of any suitable material known in the art. Objects, such as boxes, bags, parcels and/or luggage, may be placed onto queuing belt 20 and/or queuing belt 20 may receive the objects from an upstream conveyor. For example, a second queuing belt 20′ as shown in FIG. 7 can be positioned upstream or adjacent queuing belt 20 to transfer objects onto queuing belt 20. Queuing belt 20 preferably conveys, transfers or moves the objects onto a directional input device 40, as shown in FIGS. 1-9. In one preferred embodiment of this invention, directional input device 40 is positioned upstream with respect to a machine 90, such as an Explosive Detection System (EDS) or any suitable security screening machine, for example. Preferably, machine 90 comprises a machine belt 94 operatively connected to or positioned with respect to directional input device 40, so that an object can be transferred, conveyed or moved from directional input device 40 through an opening 93 formed by or in machine 90. In one preferred embodiment of this invention, a queuing belt 20 can be positioned between directional input device 40 and machine belt 94 to transfer the objects from directional input device 40 to machine belt 94. Directional input device system 10 can be used in airports, office buildings, stadiums and arenas for example, to screen objects for undesirable contents, such as firearms, drugs, explosive devices and/or other potentially dangerous contents.

In one preferred embodiment of this invention, a detecting device 22 as shown in FIG. 7, such as at least one photocell, is positioned with respect to queuing belt 20. For example, detecting device 22 may include an array 26 of photocells positioned at or within a gap 25 formed by or between two adjacent queuing belts 20, 20′, as shown in FIG. 7. Detecting device 22 detects an object as the object is transferred, conveyed or moved along queuing belt 20, and preferably is in communication with a suitable system control unit. Any suitable detecting device or mechanism and/or system control unit known to those having ordinary skill in the art and guided by the teachings herein provided can be used to detect the presence of an object on queuing belt 20. Preferably, but not necessarily, queuing belt 20 runs continuously to convey or transfer the objects onto a transfer belt 42 of directional input device 40. If the downstream security screening machine 90 is full or faulted, queuing belt 20 stops when an object is detected by detecting device 22. After security screening machine 90 is clear, queuing belt 20 restarts.

As shown in FIGS. 1-6, directional input device 40 is positioned downstream from queuing belt 20. Transfer belt 42 has an entrance end portion 44 positioned with respect to and operatively connected to a queuing belt discharge end portion 24, and a discharge end portion 46, which extends toward opening 93 in security screening machine 90. Transfer belt 42 can have any suitable width and/or length. Preferably, but not necessarily, directional input device 40 forms an opening or a spacing at entrance end portion 44 having a width about equal to a width of queuing belt 20 at discharge end portion 24. In one preferred embodiment of this invention, transfer belt 42 has a conveying surface 47 with a coefficient of friction less than a coefficient of friction of a conveying surface of queuing belt 20. In other preferred embodiments of this invention, the transfer belt coefficient of friction may be the same, similar or greater than the queuing belt coefficient of friction. Further, transfer belt 42 preferably operates, rotates or moves at a same or similar speed as a speed at which upstream queuing belt 20 operates, rotates or moves. Alternatively, in certain preferred embodiments of this invention, transfer belt 42 may move at a speed different than a speed at which queuing belt 20 moves.

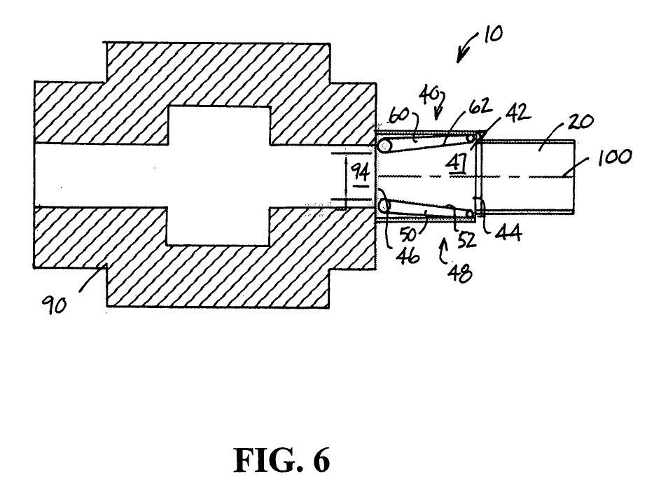

In one preferred embodiment of this invention, directional input device 40 comprises a plow-centering unit 48. Referring further to FIGS. 6-8, plow-centering unit 48 comprises at least one plow assembly 50, 60 and preferably two laterally opposing plow assemblies 50, 60 each positioned with respect to transfer belt 42. For example, first plow assembly 50 is preferably positioned at a first lateral side edge of directional input device 40 and along a first lateral edge portion 43 of transfer belt 42. Second plow assembly 60, generally opposing first plow assembly 50, is preferably positioned at a second lateral side edge of directional input device 40 and along a second lateral edge portion 45 of transfer belt 42. In one preferred embodiment of this invention, a second detecting device 51, such as at least one photocell or an array of photocells, is positioned with respect to transfer belt discharge end portion 46. Second detecting device 51 preferably, but not necessarily, is the same or similar to detecting device 22, and detects an object as the object exits directional input device 40.

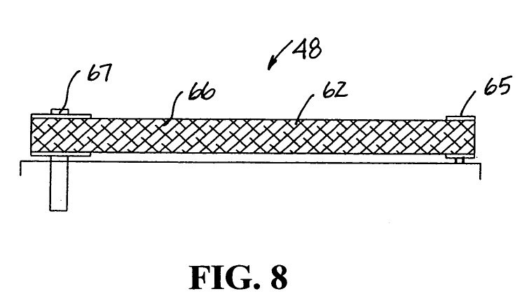

Referring further to FIGS. 7 and 8, first plow assembly 50 comprises a first plow belt 52 positioned at an angle with respect to transfer belt conveying surface 47. Preferably, first plow belt 52 is positioned generally perpendicular to conveying surface 47 and is operatively connected to and driven by a reversible drive unit 53. In one preferred embodiment of this invention, drive unit 53 comprises an independent reversible motor. It is apparent to those skilled in the art and guided by the teachings herein provided that drive unit 53 can comprise any suitable drive unit and/or motor known in the art. Drive unit 53 is shown schematically in FIG. 7 as a direct drive unit, wherein first plow belt 52 is directly mounted or attached to drive unit 53. Alternatively, drive unit 53 may include any suitable pulley and motor assembly or arrangement known to those skilled in the art and guided by the teachings herein provided. Drive unit 53 drives first plow belt 52 relative to transfer belt 42. Preferably, first plow belt 52 has a contact surface 56 with a coefficient of friction greater than the transfer belt conveying surface coefficient of friction.

First plow belt 52 is positioned about a first roller mount 55, positioned or located at entrance end portion 44 of transfer belt 42, and a second roller mount 57, positioned or located at discharge end portion 46, to funnel the objects from a wider queuing belt 20 (about 39 inches wide in one preferred embodiment of this invention) to a narrower machine belt 94, as shown in FIGS. 6 and 7. It should be apparent to those skilled in the art and guided by the teachings herein provided that the machine belt may have any suitable width and/or length. Preferably, but not necessarily, at least one of first roller mount 55 and second roller mount 57 is movable with respect to a longitudinal centerline 100 of transfer belt 42 to vary the opening or spacing of directional input device 40 at entrance end portion 44 and/or discharge end portion 46, respectively. Alternatively, in one embodiment of this invention, at least one of first roller mount 55 and second roller mount 57 can be fixed or otherwise limit a movement of first plow belt 52 about first roller mount 55 and second roller mount 57.

In one preferred embodiment of this invention, second plow assembly 60 laterally opposes first plow assembly 50 and is positioned with respect to transfer belt second edge portion 45, as shown in FIG. 7. Second plow assembly 60 comprises a second plow belt 62 positioned at an angle with respect to conveying surface 47. Preferably, second plow belt 62 is positioned generally perpendicular to conveying surface 47 and has a contact surface 66 with a coefficient of friction greater than the transfer belt conveying surface coefficient of friction. Second plow belt 62 is operatively connected to and driven by drive unit 53. Preferably, drive unit 53 drives second plow belt 62 relative to transfer belt 42 and in cooperation with first plow belt 52. In one preferred embodiment of this invention, second plow belt 62 can be driven independently from first plow belt 52 by an independent second drive unit or a slave drive unit. The second drive unit can be coupled to drive unit 53 to cooperatively drive first plow belt 52 and second plow belt 62, as desired.

Second plow belt 62 is positioned about a first roller mount 65, positioned or located at entrance end portion 44 and a second roller mount 67, positioned or located at discharge end portion 46, as shown in FIG. 7. Preferably, but not necessarily, at least one of first roller mount 65 and second roller mount 67 is movable with respect to longitudinal centerline 100 to vary the opening or spacing of directional input device 40 at entrance end portion 44 and/or discharge end portion 46, respectively. Second plow belt 62 can be moved with respect to longitudinal centerline 100 in cooperation with or independently of first plow belt 52. Alternatively, in one embodiment of this invention, at least one of first roller mount 65 and second roller mount 67 can be fixed or otherwise limit a movement of second plow belt 62.

In one preferred embodiment of this invention, directional input device system 10 comprises at least one detecting device 22 in operation control communication with drive unit 53. Preferably, at least one detecting device 22 is positioned upstream with respect to first plow belt 52 and/or second plow belt 62 to activate drive unit 53. For example, detecting device 22 may generate and/or transmit at least one control signal to drive unit 53 to provide a first plow belt operation, such as a signal to control at least one of a first plow belt speed and a first plow belt rotational direction. The first plow belt operation may comprise starting the first plow belt to rotate and/or move, stopping a rotation and/or movement of the first plow belt, increasing a first plow belt rotational speed, decreasing a first plow belt rotational speed and changing a first plow belt rotational direction.

Further, a second plow belt operation may be activated in response to the at least one control signal generated and/or transmitted by detecting device 22 to drive unit 53. For example, in response to a control signal received by drive unit 53 from detecting device 22, first plow belt 52 rotates and/or moves in one of a first direction and an opposite second direction and second plow belt 62 preferably rotates and/or moves in a direction opposite a direction in which first plow belt 52 rotates and/or moves. Further, second plow belt 62 may rotate and/or move at a speed different than a speed at which first plow belt 52 rotates and/or moves. Detecting device 22 may generate and/or transmit a control signal to drive unit 53 to provide a second plow belt operation independently of or in cooperation with the first plow belt operation, such as a signal to control at least one of a second plow belt speed and a second plow belt rotational direction. The second plow belt operation may comprise starting the second plow belt to rotate and/or move, stopping a rotation and/or movement of the second plow belt, increasing a second plow belt rotational speed, decreasing a second plow belt rotational speed and changing a second plow belt rotational direction.

In one preferred embodiment of this invention, directional input device system 10 includes a photocell array 26 including a plurality of photocell sensors or other suitable detecting elements spaced along a width of queuing belt 20. Preferably, the photocell sensors are evenly positioned along the width of queuing belt 20, for example about 3/4 inch apart. As shown in FIG. 7, photocell array 26 is preferably positioned at or within gap 25 formed between adjacent queuing belts 20, 20′. Each photocell sensor projects a beam or ray of light through gap 25 between adjacent queuing belts 20, 20′ in a general vertical alignment and/or direction. Photocell array 26 generates and/or transmits at least one, and preferably a plurality of center point signals to a controller 70 operatively connected to photocell array 26. Controller 70 receives the center point signals and determines a center point of the object, such as a bag, a box, or a piece of luggage, as the object passes over photocell array 26. Controller 70 is in information communication with a system controller 75, preferably via analog communication signals. In response to the center point signals transmitted from photocell array 26 by controller 70, system controller 75 determines a centerline of the object preferably generally parallel to a longest side or edge of the object, based on the center point signals generated as the object travels or moves over photocell array 26. System controller 75 then controls operation of first plow belt 52 and a corresponding or cooperating operation of second plow belt 62 based on the determinations to center the object along longitudinal centerline 100 and with respect to machine opening 93. For example, based on the signals received by system controller 75, first plow belt 52 may be activated to rotate or move in the transfer belt movement direction and second plow belt 62 may be activated to move in an opposite direction.

Thus, in one preferred embodiment of this invention, one of first plow belt 52 and second plow belt 62 is activated to rotate and/or move in a direction in which transfer belt 42 moves and the opposing plow belt moves in an opposite direction to the activated plow belt direction. Preferably, but not necessarily, first plow belt contact surface 56 and second plow belt contact surface 66 each has a coefficient of friction different than a coefficient of friction of transfer belt conveying surface 47. In one preferred embodiment of this invention, at least one of the first plow belt contact surface coefficient of friction and the second plow belt contact surface coefficient of friction is greater than the transfer belt conveying surface coefficient of friction. Because the contact surface of the plow belts has a greater coefficient of friction than the transfer belt conveying surface coefficient of friction, when the object contacts the plow belt contact surface, the object pivots or rotates with respect to conveying surface 47 so that it is aligned with the machine opening downstream.

In one preferred embodiment of this invention, at least one of first plow belt 52 and second plow belt 62 rotates and/or moves at a speed different than a speed at which transfer belt 42 rotates and/or moves. For example, first plow belt 52 and second plow belt 62 each preferably rotates and/or moves at a speed greater than a speed at which transfer belt 42 rotates and/or moves. It should be apparent to those skilled in the art and guided by the teachings herein provided that transfer belt 42, first plow belt 52 and/or second plow belt 62 can be replaced with any suitable mechanical conveyor, such as a plurality of aligned or parallel rollers, which may be operated by a gear system.

The present invention is described in further detail in connection with the following example which illustrates or simulates various aspects involved in the practice of the invention. It is to be understood that all changes that come within the spirit of the invention are desired to be protected and thus the invention is not to be construed as limited by this example.

### EXAMPLE

### Bag Flow Through the Directional Input Device

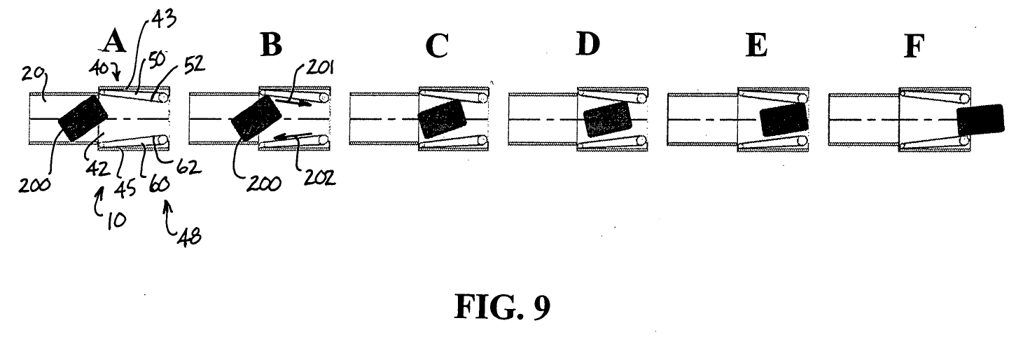

FIG. 9 illustrates directional input device system 10 aligning and centering a bag 200 as the bag 200 is conveyed through directional input device 40, in accordance with one preferred embodiment of this invention. Directional input device system 10 can include one or more additional devices that detect the position and/or orientation of the bag 200 at queuing belt 20. Operation of plow-centering unit 48 can be modified or adjusted based on the lateral position or placement of the bag 200 on queuing belt 20 and/or the bag orientation, such as the degree of skew or slant, with respect to queuing belt 20 and/or transfer belt conveying surface 47.

Referring to FIGS. 7 and 9, as the bag 200 is received on queuing belt 20, the bag 200 is transferred onto plow-centering unit 48 unless a downstream security screening machine 90 (not shown in FIG. 9) is full or faulted. As the bag 200 travels along queuing belt 20, the bag 200 blocks photocell array 26, or any suitable detecting device 22, positioned or located with respect to queuing belt 20 and starts a timer on a Programmable Logic Controller (PLC) or other suitable device such as a computer, which can be programmed to control one or more machines or devices, for example.

As the bag 200 exits queuing belt 20, the bag 200 is received on transfer belt 42. If the bag 200 is positioned on transfer belt 42 so that the bag 200 cannot fit through opening 93 in security screening machine 90, the position and/or orientation of bag 200 is detected by or using detecting device 22. When the bag position and/or orientation is known or detected, the associated plow belt 52 for example, preferably moves in the same direction as transfer belt 42, as shown in FIG. 9 by an arrow 201 in position B, and opposing plow belt 62 preferably moves in the opposite direction, as shown by an arrow 202 in position B. In one preferred embodiment of this invention wherein plow belts 52, 62 are traveling at a slightly faster speed than transfer belt 42, the bag 200 is positioned (aligned and centered) on transfer belt 42 as the bag 200 is conveyed downstream. As the aligned and centered bag 200 exits plow-centering unit 48, the bag 200 blocks the photocell, or other suitable detecting device 51, preferably positioned or located between plow-centering unit 48 and security screening machine belt 94 or an adjacent conveyor to stop and reset the PLC timer. If the PLC times out before the bag 200 is detected by the second photocell, directional input device system 10 shuts down, and a fault alarm is activated on directional input device system 10.

Once started, transfer belt 42 preferably runs continuously. Operation of plow belts 52, 62 is initiated by detecting device 22. In one preferred embodiment of this invention, a direction in which each plow belt 52, 62 rotates, moves or travels depends on bag position and/or orientation detected using detecting device 22. For the example shown in FIG. 9, the first plow assembly 50 is activated, and associated first plow belt 52 starts to rotate, move or run in the same direction as transfer belt 42 while second plow assembly 60 is activated so that associated second plow belt 62 rotates, moves or runs in a direction opposite the direction in which first plow belt 52 rotates, moves or runs. Referring to FIG. 9, if for example bag 200 is skewed towards second edge portion 45 (rather than first edge portion 43 as shown), second plow assembly 60 is activated to run associated second plow belt 62, and associated second plow belt 62 starts to rotate, move or run in the same direction as transfer belt 42, while first plow belt 52 is activated to rotate, move or run in an opposite direction.

Thus, the invention provides a directional input device including a plow-centering unit having opposing plow assemblies positioned generally perpendicular to the transfer belt, and operatively controlled by a drive unit, for aligning objects on the transfer belt with an opening in a machine used for screening the contents of the objects, for example.

In the drawings of various embodiments of this invention, various elements of this invention comprise a particular material. However, it is apparent to those skilled in the art that the elements may comprise any suitable material, including but not limited to metals, alloys, plastics, graphite materials and composite materials.

The invention illustratively disclosed herein suitably may be practiced in the absence of any element, part, step or component, which is not specifically disclosed herein.

While in the foregoing description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A directional input device for aligning an object with respect to a system restriction, the directional input device comprising:
a transfer belt having a conveying surface extending toward the system restriction;
a first plow assembly positioned with respect to the transfer belt, the first plow assembly comprising a first plow belt positioned generally perpendicular to the transfer belt; and
a drive unit operatively connected to the first plow assembly to drive the first plow belt relative to the transfer belt.

2. The directional input device of claim 1 wherein the first plow assembly is positioned with respect to an edge portion of the transfer belt.

3. The directional input device of claim 1 wherein the drive unit comprises an independent reversible motor.

4. The directional input device of claim 1 wherein a contact surface of the first plow belt has a coefficient of friction greater than a coefficient of friction of the conveying surface.

5. The directional input device of claim 1 further comprising a roller mount limiting a movement of the plow belt.

6. The directional input device of claim 1 wherein the system restriction comprises an opening formed by a machine.

7. The directional input device of claim 1 further comprising a detecting device positioned with respect to an entrance end portion of the transfer belt and detecting at least one of a position and an orientation of the object with respect to the directional input device, the detecting device in operation control communication with the drive unit to activate the drive unit.

8. The directional input device of claim 7 wherein the drive unit is activated to provide a first plow belt operation in response to at least one of the object position and the object orientation.

9. The directional input device of claim 8 wherein the first belt operation comprises at least one of starting a rotation of the first belt, stopping a rotation of the first belt, increasing a first belt rotational speed, decreasing the first belt rotational speed, and changing a first belt rotational direction.

10. The directional input device of claim 1 further comprising a detecting device positioned with respect to a discharge end portion of the transfer belt.

11. The directional input device of claim 1 further comprising:
a second plow assembly positioned with respect to the transfer belt and laterally opposing the first plow assembly, the second plow assembly comprising a second plow belt positioned generally perpendicular to the transfer belt,
wherein the drive unit is operatively connected to the second plow assembly.

12. A directional input device for aligning an object with respect to an opening formed by a machine, comprising:
a transfer belt having a conveying surface extending toward the opening;
a plow-centering unit mounted with respect to the conveying surface, and including a first plow assembly positioned with respect to a first edge portion of the transfer belt and a second plow assembly positioned with respect to a second edge portion of the transfer belt, each plow assembly comprising a plow belt positioned generally perpendicular to the transfer belt;
a reversible first drive unit operatively connected to the first plow assembly to drive the first plow assembly belt relative to the transfer belt; and
a reversible second drive unit operatively connected to the second plow assembly to drive the second plow assembly belt relative to the transfer belt.

13. The directional input device of claim 12 further comprising at least one detecting device in operation control communication with the first drive unit, wherein a first plow belt operation is activated in response to a control signal generated by the at least one detecting device.

14. The directional input device of claim 13 wherein a second plow belt operation is activated in response to the control signal.

15. The directional input device of claim 13 wherein in response to the control signal received by the first drive unit from the at least one detecting device, the first plow belt moves in one of a first direction and a second direction.

16. The directional input device of claim 15 wherein the second plow belt moves in a direction opposite a direction in which the first plow belt moves.

17. The directional input device of claim 15 wherein the second plow belt moves at a speed different than or the same as a speed at which the first plow belt moves.

18. The directional input device of claim 13 wherein the at least one detecting device is in operation control communication with the second drive unit, wherein a second plow belt operation is activated in response to the control signal generated by the at least one detecting device.

19. The directional input device of claim 18 wherein, in response to the control signal received by the second drive unit from the at least one detecting device, the second plow belt moves in a direction opposite a direction in which the first plow belt moves.

20. The directional input device of claim 12 wherein one of the first plow belt and the second plow belt is activated to move in a direction in which the transfer belt moves and the opposing plow belt moves in an opposite direction to the activated plow belt direction.

21. The directional input device of claim 12 wherein a first plow belt contact surface and a second plow belt contact surface each has a coefficient of friction different than a coefficient of friction of the conveying surface.

22. The directional input device of claim 12 wherein one of the first plow belt and the second plow belt rotates in a direction opposite a direction in which the transfer belt rotates.

23. The directional input device of claim 12 wherein at least one of the first plow belt and the second plow belt rotates at a speed different than a speed at which the transfer belt rotates.

24. A luggage handling system comprising:
a queuing belt;
a directional input device positioned downstream from the queuing belt, the directional input device comprising a transfer belt having an entrance end portion operatively connected to a discharge end portion of the queuing belt and a plow-centering unit; and
a machine positioned downstream from the directional input device, the machine having a machine belt operatively connected to a discharge end portion of the transfer belt, the machine forming an opening corresponding to a width of the transfer belt discharge end portion.

25. The luggage handling system of claim 24 wherein the plow-centering unit further comprises:
a first plow assembly positioned with respect to a first edge portion of the transfer belt, the first plow assembly including a first plow belt positioned generally perpendicular to the transfer belt and operatively connected to and driven by a drive unit; and
a second plow assembly laterally opposing the first plow assembly and positioned with respect to a second edge portion of the transfer belt, the second plow assembly including a second plow belt positioned generally perpendicular to the transfer belt and operatively connected to and driven by the drive unit.

26. The luggage handling system of claim 25 further comprising:
a detecting device in operation control communication with the drive unit, the detecting device transmitting a control signal to the drive unit to control at least one of a first plow belt speed and a first plow belt rotational direction, the control signal further controlling at least one of a second plow belt speed and a second plow belt rotational direction.

27. The luggage handling system of claim 24 further comprising:
a photocell array positioned with respect to the queuing belt, the photocell array including a plurality of sensors evenly positioned along a width of the queuing belt, the photocell array generating a plurality of center point signals;
a controller operatively connected to the photocell array, the controller receiving the plurality of center point signals and determining a center point of an object positioned with respect to the queuing belt; and
a system controller in information communication with the controller, the system controller determining a centerline of the object based on the generated center point signals to control operation of the plow-centering unit.

28. The luggage handling system of claim 24 further comprising a second queuing belt positioned between the directional input device and the machine.
